(19) United States
(12) Patent Application Publication
(10) Pub. No.: US 2006/0267301 A1
(43) Pub. Date: Nov. 30, 2006

(54) Apparatus for holding and transporting golf clubs

(76) Inventor: Daniel J. Tuntland, Las Vegas, NV (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/135,966

(22) Filed: May 24, 2005

(51) Int. Cl. B62B 1/00

(52) U.S. Cl. 280/47.26

(57) ABSTRACT

The present invention relates to an apparatus for holding and transporting golf clubs and/or golf bags. The present invention includes the use of one or more support members and support wheels to allow easy transportation of golf clubs without the need for having several pieces of equipment. With the present invention a single apparatus allows a person to hold their golf clubs and golf equipment and easily and conveniently transport them.

### FIELD OF INVENTION

The present invention relates to an apparatus for holding and transporting golf clubs and other golfing equipment.

### BACKGROUND OF INVENTION

Golf club sets are heavy, bulky and usually include nine or more clubs. Consequently, golf clubs are typically held in golf bags that can accommodate nine or more clubs and other golfing equipment, such as shoes, balls, tees, etc. Golf bags typically include a handle and/or a strap that a person uses to carry the bag. However, if a large number of golf clubs or a large amount of golfing equipment are placed inside the bag, the bag may become heavy and/or unwieldy. Additionally, the bag may place excessive strain on the carrier.

Devices exist that allow a user to carry golf bags large distances. For example, there are golf travel bags that are used to transport golf bags when a person is traveling with their golf clubs. Travel bags typically include wheels to allow a traveler to roll their golf bag, such as when traveling through an airport. In addition to travel bags, there are also pull carts that are used to transport golf bags on a golf course. Pull carts are typically frames with wheels, the frame being configured to hold a golf bag.

### SUMMARY OF THE INVENTION

The present invention provides an apparatus for holding and transporting golf clubs that advantageously allows a person to hold and/or transport their golf clubs and golfing equipment. The apparatus includes a container configured to hold golf clubs and a first base wheel, which is rotatably connected to a base of the container. The apparatus also includes a first support member, a first end of the first support member being pivotally connected to the container. A first support wheel is rotatably connected to a second end of the first support member. The apparatus also includes a handle connected to the container.

A person may operate the apparatus by holding the handle, tilting the apparatus so that the weight of the apparatus is on the first base wheel and the first support wheel and rolling the apparatus. Advantageously, with the apparatus an operator does not have to “carry” the weight of the apparatus when rolling the apparatus. Rather, the operator merely pulls the apparatus with the handle. Because the weight of the apparatus, golf clubs and/or golfing equipment in the apparatus, is on the first base wheel and support wheel the apparatus avoids strain on a person's shoulder, back and arms.

Various refinements exist of the features noted in relation to this first aspect of the present invention. Further features may also be incorporated in the first aspect. These refinements and additional features may exist individually or in any combination. For instance, the first support member may pivot about a horizontal axis, a vertical axis or an axis between horizontal and vertical when the apparatus is in an upright position. As another example, the apparatus may include more than one support member.

A second aspect of the present invention is an apparatus for holding and transporting golf clubs. The apparatus includes a container configured to hold golf clubs. First and second base wheels are rotatably connected to the base of the container. The apparatus also includes a support member; a first end of the support member is pivotally connected to the container. The support member is pivotable from a support member stored position to a support member extended position. A support wheel is rotatably connected to a second end of the support member. The apparatus also includes a handle, which is connected to the container.

Various refinements exist of the features noted in relation to the second aspect of the present invention. Further features may also be incorporated in the second aspect. These refinements and additional features may exist individually or in any combination. For example, the support wheel in addition to rotating along a horizontal axis of rotation, e.g., rolling along the ground, may also have a vertical axis of rotation that allows the wheel to turn or pivot while it rolls along the ground. As another example, the apparatus may include a groove for storing the support member when the support member is in the support member stored position. Additionally the handle may be movable from a stored handle position to an extended handle position by either sliding or folding.

Another aspect of the present invention includes an apparatus for holding and transporting golf clubs that includes a container configured to hold golf clubs. The apparatus also includes a first rolling means for rolling the apparatus, the first rolling means being rotatably connected to a base of the container. The apparatus also includes a support means for supporting at least a portion of the apparatus when the apparatus is being rolled. A second rolling means for rolling the apparatus is rotatably connected to the support means. The apparatus also includes a holding means for holding the apparatus when rolling the apparatus. The holding means is also connected to the container.

### BRIEF DESCRIPTION OF THE DRAWINGS

FIG. 1 is a perspective view of one embodiment of the present invention that includes a support arm with a support wheel.

FIG. 2 is a side view of the first embodiment of the present invention showing the support arm being pivotable from a stored position to an extended position.

FIG. 3 is a side view of an embodiment of the present invention that includes a handle that pivots from a stored position to an extended position.

FIG. 4 is a perspective view of an embodiment of the present invention that includes a support arm that pivots about a vertical axis of rotation.

FIG. 5 is a perspective view of an embodiment of the present invention that includes a support arm storage groove.

FIG. 6 is a perspective view of an embodiment of the present invention that includes two support arms.

### DESCRIPTION OF THE INVENTION

The present invention in one aspect is directed to an improved apparatus for holding and transporting golf clubs and golfing equipment. Several embodiments of the present invention are described below. The specific embodiments described below are for illustrative purposes only, and it should be understood that the present invention is not limited to the specific embodiments described below. In the following description, the phrases “holding golf clubs;” “carrying golf clubs;” “placing golf clubs;” “removing (or taking out) golf clubs” and variations thereof, are intended to include the situation where the individual golf clubs are “held,” “carried,” “placed,” or “removed (taken out)” and also the situation where a golf bag containing golf clubs, are “held,” “carried,” “placed,” or “removed (taken out).”

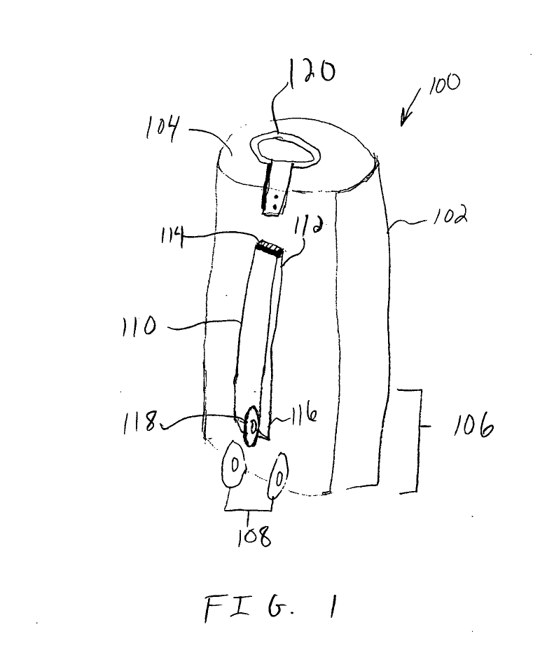

FIG. 1 shows an apparatus 100 for holding and/or transporting golf clubs in accordance with one embodiment of the present invention. The apparatus 100 includes a container 102 configured to hold golf clubs. In this embodiment, the apparatus 100 includes an opening 104, which allows golf clubs to be placed within container 102. Container 102 also includes a base 106. Rotatably connected to the base 106 are a pair of wheels 108 that are used when rolling apparatus 100. The term “rotatably connected” describes a manner in which wheels (e.g., wheels 108) are adapted to rotate about at least one axis of rotation so that the wheels may roll along the ground. A handle 120 is also connected to container 102.

Apparatus 100 also includes support member 110, which is pivotally connected to container 102. The term “pivotally connected” describes a manner in which a support member (e.g., support member 110) is adapted to pivot about at least one axis. In the embodiment shown in FIG. 1, a first end 112 of support member 110 is pivotally connected to container 102 with a hinge 114. Hinge 114 allows support member 110 to pivot about a horizontal axis, when apparatus 100 is in an upright position as shown in FIG. 1. Those skilled in the art are readily familiar with hinges and their various substitutes. Connected to a second end 116 of support member 110 is a support wheel 118.

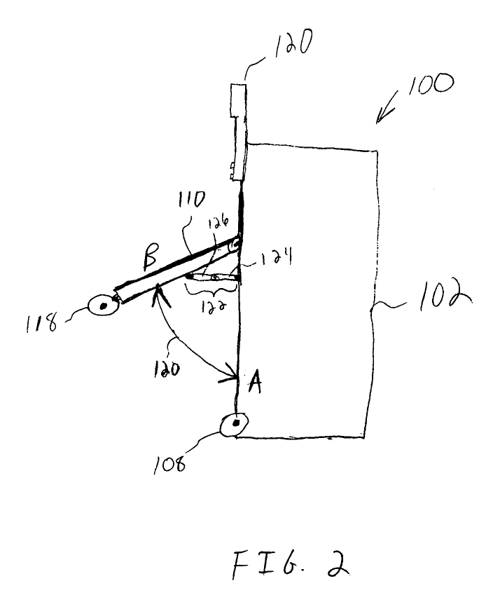

FIG. 2 is a side view of apparatus 100, and illustrates “pivoting” of support member 110. As shown in FIG. 2, support member 110 is pivotable from a stored position indicated as A, to an extended position indicated as B. The support member 110 may be manually pivoted from position A to position B. In some embodiments, support member 110 may include a handle to aid in pivoting to and from position A to position B. When support member 110 is in the extended position B it forms an angle 120 with container 102. FIG. 2 shows angle 120 as an acute angle. However, it is should be appreciated that angle 122 may, in other embodiments, be a 90° angle or an obtuse angle. Also shown in FIG. 2 is a locking mechanism 122 that is used to lock support member 110 in the extended position B. The locking mechanism 122 shown in FIG. 2 includes a first locking arm 124 that is pivotally connected to container 102 on one end, and pivotally connected to a second locking member 126 on the other end. The second locking member 126, in addition to being pivotally connected to the first locking member 124, is also pivotally connected to support member 110. The invention, however, is not intended to be limited to the locking mechanism 122 provided by members 124 and 126. Those skilled in the art are familiar with various means to provide such locking functionality. Providing such locking functionality is often a matter of design choice.

Apparatus 100 may be operated by holding the handle 120, tilting apparatus 100 so that the weight of apparatus 100 is on wheels 108 and support wheel 118 when rolling apparatus 100. Advantageously, with apparatus 100 an operator does not have to “carry” the weight of apparatus 100 when rolling apparatus 100. Rather, the operator merely pulls apparatus 100. Because the weight of apparatus 100, golf clubs and/or golfing equipment in apparatus 100, is on wheels 108 and support wheel 118, apparatus 100 avoids strain on a person's shoulder, back and arms.

Referring now to container 102, it is configured to hold golf clubs. In one embodiment container 102 may include structures that separate individual golf clubs and prevent them from damaging each other by coming in contact with each other. In some embodiments, the partitions may extend the entire length of container 102, creating individual compartments for each club. In other embodiments, container 102 may include pockets or other compartments useful for holding items such as tees, balls, hats, umbrellas etc. Additionally, the container 102 preferably has a length that allows the majority of the shaft of standard golf clubs to be disposed within container 102.

Container 102, it may be made of any suitable material with sufficient wear and impact resistance to handle holding and transporting golf clubs. In one specific embodiment, the container 102 includes a soft outer shell. Some nonlimiting examples of materials that may be used in the soft outer shell of container 102 include nylon, polyester, MYLAR®, KEVLAR®, canvas, leather and combinations thereof. One advantage of using a soft outer shell for container 102 is the ease with which additional pockets may be added to the soft outer shell for carrying other golfing equipment such as balls, tees, shoes etc. In those embodiments in which the container 102 includes a soft outer shell, it may also include padding to protect the golf clubs from damage during transportation. The padding may be made from any material useful for absorbing impacts, a nonlimiting example including foam materials.

In another exemplary embodiment, the container 102 includes a hard outer shell. Some nonlimiting examples of materials that may be used in the hard outer shell of container 102 include hard plastics, rubber, metals and combinations thereof. One advantage of using a hard outer shell for container 102 is that the golf clubs are better protected against impacts during transportation, such as through luggage handling equipment.

In yet other embodiments the container 102 may have an outer cover that includes both hard materials and soft materials. For example, in one embodiment container 102 may include an outer shell made primarily of a soft material such as, for example, nylon, but also include portions made of a hard material, such as for example a hard plastic. The hard material may be located in places to facilitate connection of other components. For example, base 106 of container 102 may include a hard plastic to facilitate attachment of wheels 108, or may include hard plastic at locations to help facilitate the attachment of handle 120 or support arm 110 to container 102.

As stated above, the apparatus 100 includes an opening 104 to allow the golf clubs to be placed within container 102. In some embodiments the apparatus 100 may include a cover that is adapted to fit over opening 104 to completely cover opening 104. The cover may be useful for when the apparatus 100 will be checked in as luggage to prevent the golf clubs from falling out of the container 102. The cover may be removable to allow the golf clubs to be taken out of and placed back in the container 102, for example when on a golf course.

It should be understood that the use of opening 104 is merely one embodiment of the present invention. Any method for allowing golf clubs to be placed within container 102 may be used. For example, in one embodiment container 102 may be made of a soft material and opening 104 may be a slit that extends along the length of container 102. In this embodiment, the apparatus 100 may include a device(s) for closing the slit to prevent the golf clubs from falling out of container 102, such as a zipper, row of buttons, belts with clips and buckles, hook and loop fasteners, a combination of the foregoing or other appropriate device(s).

In yet another embodiment container 102 may not include the opening 104, but still be made in a way that allows golf clubs to be placed in and taken out of container 102. For example, the container 102 may be made of two pieces of a hard material. The two pieces may be connected together with a hinge(s) or locking mechanisms. In this embodiment, the two pieces may be hinged open to place golf clubs within the container, and hinged closed when transporting golf clubs. This embodiment is useful in situations where golf clubs are likely to encounter hard impacts such as when being transported as luggage.

The base 106 of container 102 may include a hard material to facilitate connection of wheels 108. The hard material may be part of the outer shell of container 102 as mentioned above, or may be used in constructing base 106 and not visible from the outside. However, one advantage of having a hard material as part of the outer shell at base 106 is for wear resistance. Because base 106 is at the bottom of apparatus 100 it is more likely to be scraped against the ground or against walls when someone is rolling apparatus 100. Consequently it is advantageous to have a hard material that is better able to withstand the wear as the outer shell of base 106.

Referring back to FIG. 1, wheels 108 are rotatably connected to base 106 of container 102 in a way that allows wheels 108 to rotate about a horizontal axis of rotation. Any device(s) that connect wheels 108 but still allows each to rotate freely about at least one axis of rotation when the apparatus is being rolled, may be used to connect wheels 108 to base 106. Although the embodiment shown in FIG. 1 shows both wheels 108 rotatable about a horizontal axis of rotation when being rolled along the ground, in other embodiments each of the wheels 108 may have a different axis of rotation when rolled along the ground that is not horizontal. For example, the wheels may be slightly tilted at an angle when on the ground, so that they rotate about an axis of rotation that is not exactly horizontal. In some embodiments wheels 108 will have more than one axis of rotation. For example, wheels 108 may rotate about a vertical axis of rotation, which allow the wheels to turn or swivel. The additional axis of rotation may provide additional steering control over apparatus 100 by allowing the wheels to turn or swivel while they are rolling along the ground, which makes steering apparatus 100 relatively easier.

Wheels 108 may be made from any material or combination of materials with adequate strength to handle the weight of golf clubs carried in apparatus 100, and wear resistance to handle rolling on a variety of surfaces including concrete and asphalt. Some nonlimiting examples of suitable materials include plastic, rubber, metal and combinations thereof.

Wheels 108 may have a variety of designs. For example in one embodiment, wheels 108 may each be made of a solid piece of plastic or rubber and include a hole in the center for an axle. In another embodiment, wheels 108 may each include a rim and a tire that fits around the outside of the rim. In this embodiment, the rim may have any common design, such as for example a design that includes spokes and a hub. The tire may be an inflatable tire, with or without an inner tube, or the tire may be made from a solid piece of plastic or rubber. Additionally, the wheels may include other devices that that serve other purposes such as to aid the wheels in rotating or connecting to the container 102. For example, the wheels may include bearings, bushings, gears etc. The foregoing are merely some illustrative examples and wheels 108 are not limited to the designs discussed above.

Wheels 108 are merely one example of rolling devices that may be used with the present invention. It should be appreciated that other rolling means for rolling apparatus 100 may be used instead of or in addition to wheels 108. Some nonlimiting examples that may be used include: wheels; rollers; roller balls and combinations thereof.

As previously stated the design of apparatus 100 shown in FIGS. 1 and 2 is only one embodiment of the present invention. In other embodiments, apparatus 100 may include only one wheel connected to base 106, instead of the two wheels 108 shown in FIGS. 1 and 2. In yet other embodiments, apparatus 100 may include more than two wheels, such as for example three or more. Moreover, as previously stated apparatus 100 may include other rolling devices in addition to, or instead of, wheels 108.

In other embodiments, the position of wheels 108 on base 106 may also vary from that shown in FIG. 1. For example, referring back to FIG. 1, wheels 108 may be horizontally spaced more closely together than shown in FIG. 1. Alternatively wheels 108 may be horizontally spaced further apart than shown in FIG. 1. In one embodiment, wheels 108 are horizontally spaced so that at least a portion of each individual wheel protrudes beyond the edge(s) or wall of container 102.

Referring back to FIG. 2, wheels 108 may be positioned vertically in a different position than shown in FIG. 2. For example in one embodiment wheels 108 may be vertically positioned further down along container 102, so that the left side of apparatus 100 is slightly elevated with respect to the right side of apparatus 100, when apparatus 100 is upright. In other embodiments, wheels 108 may be positioned vertically higher up on container 102. In yet other embodiments, apparatus 100 may include two or more pairs of wheels each pair vertically positioned at different locations along container 102. This embodiment may be useful when apparatus 100 is being rolled up a flight of stairs.

Support member 110 may be made using any material with adequate properties to support the weight of apparatus 100 and golf clubs within the apparatus 100 when apparatus 100 is tilted and being rolled. Some nonlimiting examples of materials that may be used in making support member 110 include: plastic, rubber, metal and combinations thereof.

The size and shape of support member 110 is not limited to that shown in FIG. 1. For example, in some embodiments support member 110 may be as wide as, or slightly less than, the width of container 102. In other embodiments support member 110 may be very narrow. In yet other embodiments, the first end 112 and the second end 116 may have different widths. For example, first end 112 may have a wide width and taper to a narrower width at second end 116, or vice versa. Additionally, support member 110 is not limited to a single solid piece. Rather, support number 110 may be made of multiple pieces or parts. For example, support member 110 may be constructed of a plurality of components that allow for the support member to extend from a stored position A to an extended position B (e.g., via telescoping components and/or folding components). Those skilled in the art are readily familiar with such construction.

Moreover, apparatus 100 is not limited to only a single support member 110. In some embodiments, apparatus 100 may include two or more support members. The support members may be connected to each other so that they all extend from their stored position to their extended position simultaneously, such as for example with cross members. Alternatively, each member may extend from their stored position to their extended position individually. Furthermore, in some embodiments each individual support member may have a support wheel, while in other embodiments that may not be the case.

In those embodiments of the present invention, which include a support means, all of the alternative structures described above with respect to support member 110 may be used. Moreover, other structures not disclosed above, but functioning to support apparatus 100 when being rolled, may also be used.

Referring back to FIG. 1, the first end 112 of support member 110 is pivotally connected to container 102 with hinge 114, which allows support member 112 to pivot about a horizontal axis from the stored position A to the extended position B. Hinge 114 may be any device(s) or combination of devices that allows support member 110 to be pivotally connected to container 102 to allow support member 110 to pivot from the stored position A to the extended position B, some nonlimiting examples including: a hinge, any device that includes a pivot pin, a flexible piece of material or a combination thereof. In one embodiment, support member 110 is permanently and rotatably connected to container 102. “Permanently connected” describes a manner in which support member 110 is not easily removable or detachable from container 102. In other words, support member is connected to container 102 in a permanent, fixed manner.

The second end 116 of support member 110 is rotatably connected to support wheel 118. As stated above with respect to wheels 108, support wheel 118 may be made from any material or combination of materials with adequate strength to handle the weight of golf clubs carried in apparatus 100, and with sufficient wear resistance to handle rolling on a variety of surfaces including concrete and asphalt. Some nonlimiting examples of suitable materials include plastic, rubber, metal and combinations thereof. Support wheel 118 may have a variety of designs, such as those previously described with respect to wheels 108.

Also as described above, support wheel 118 is merely one example of rolling devices that may be used with the present invention. It should be noted that other rolling devices for rolling apparatus 100 may be used instead of or in addition to support wheel 118. Some nonlimiting examples that may be used include: wheels, as described above with respect to wheels 108; rollers; roller balls and combinations thereof.

Support wheel 118 is connected to support member 110 in a way that allows support wheel 118 to rotate about at least one axis of rotation, so that apparatus 100 may be rolled. In FIG. 1, support wheel 118 rotates about a horizontal axis of rotation when rolling along the ground. Additionally, in some embodiments support wheel 118 may be rotatable about more than one axis of rotation, such as about a horizontal axis and a vertical axis, when rolling along the ground. In this embodiment, the vertical axis of rotation may allow better control over steering apparatus 100 when it is being rolled. The vertical axis of rotation may allow support wheel to turn while it is rolling along the ground.

In those embodiments that include a rolling means, any structure or rolling device, described above with respect to wheels 108 or support wheel 118 may be used. Moreover, other structures not disclosed above, but functioning to allow apparatus 100 to roll, may also be used.

Handle 120 may be made of any material that is suitable for use as a handle in apparatus 100, some nonlimiting examples including: plastic, rubber, metal and combinations thereof. The design of handle 120 is not limited to straight pieces as shown in FIGS. 1 and 2, but may include curved pieces or other designs not shown in FIGS. 1 and 2 that are more ergonomic. In yet other embodiments, handle 120 may have a simpler design than shown in FIGS. 1 and 2. For example, in some embodiments where container 102 includes a soft outer shell, handle 120 may simply be a piece of material attached (e.g., sewn and/or riveted) to the soft outer shell.

In the embodiment shown in FIGS. 1 and 2, handle 120 substantially extends beyond the top of container 102. The fact that handle 120 substantially extends beyond the top of container 102 may present a problem when apparatus 100 is checked in as luggage, because handle 120 may be caught on other luggage or on luggage handling equipment. Accordingly, in one specific embodiment of the present invention, handle 120 is movable from a stored handle position to an extended handle position. In this embodiment when handle 120 is in the stored handle position it does not substantially extend beyond the top of apparatus 100. It should be understood that in some cases handle 120 may still extend beyond the top of apparatus 100 when in the stored handle position, but not substantially. When handle 120 is in the extended handle position it will substantially extend beyond the top of apparatus 100, making it more convenient for someone to hold onto and roll apparatus 100.

The handle 120 may be movable for example by sliding. The sliding of handle 120 may be accomplished using any appropriate device or combination of devices. For example, the sliding of handle 120 may be accomplished by the use of a first elongated member of a first diameter and a hollow elongated member of a diameter larger than the first diameter. The handle 120 may be connected to one of the members. The handle 120 may then be slid from the stored handle position, where the first elongated member is substantially disposed within the hollow elongated member, and the extended handle position, where the first elongated member is substantially outside the hollow elongated member. For example, handle 120 may telescope from a stored position to an extended position, or vice versa. Additionally, the extended position of handle 120 may be adjustable to different lengths using, for example, a locking mechanism that maintains the extended position at a particular length. This feature is useful for changing the length of the handle to accommodate the height of a user, i.e. a taller user may prefer a longer length, and a shorter user may prefer a shorter length. Those skilled in the art are familiar with locking mechanisms that allow the handle to be locked at various heights. Other devices or methods for sliding handle 120 may be used, a nonlimiting example including the use of a channel and a rail that fits within the channel.

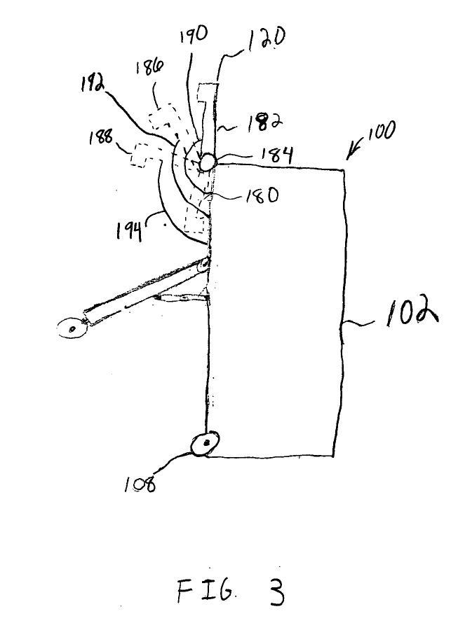

Alternatively, or in addition to sliding, handle 120 may be movable by being folded from a stored position to an extended position, and vice versa, about a pivot point (e.g., a hinge or pivot pin). FIG. 3 is a side view of one embodiment of apparatus 100 that includes a handle 120 that is folded from a stored position 180 to an extended position 182 about a pivot pin 184. All parts of apparatus 100 shown in FIG. 3, which are similar to parts previously described with respect to FIGS. 1 and 2 are numbered the same as in FIGS. 1 and 2. The embodiment shown in FIG. 3 also includes a locking mechanism (not shown) that allows handle 120 to be locked at three different positions 182, 186 and 188 that are at three different angles 190, 192 and 194 respectively with respect to the container 102. For example, the handle 120 may be set at one of the positions based on a height of a user. A taller user may prefer the handle be locked at position 182, whereas a shorter user may prefer position 188. It should be appreciated that FIG. 3 is merely illustrative and in other embodiments, handle 120 may lock at more than three different positions, such as four, five or more than five different positions. In yet other embodiments, handle 120 may lock at less than three different positions, such as one or two different positions.

In those embodiments of the present invention that include a holding means, any structure, described above with respect to handle 120 may be used. Moreover, other structures not disclosed above, but functioning to allow a person to hold onto and pull on apparatus 100 may also be used.

In yet another embodiment of the present invention, apparatus 100, in addition to a movable handle 120, may include a handle storage grove. The handle storage groove is a space or volume into which at least a portion of handle 120 is disposed, when the handle 120 is in the stored handle position. The handle storage groove may be a channel or groove in container 102. The addition of the handle storage groove further helps in keeping the handle 120 from getting caught on other luggage or luggage handling equipment. Another feature that may be included in some embodiments is a handle storage groove cover. The handle storage groove cover may be used to at least partially cover the handle storage groove.

Referring again to FIG. 2, apparatus 100 includes a locking mechanism 122 that is used to lock support member 110 in the support member extended position B. As stated above, locking mechanism 122 includes a first locking member 124 and a second locking member 126. The locking members may be made using any appropriate materials, such as the ones previously described with respect to support member 110. The locking mechanism 122 is only one example of a locking mechanism that may be used with the present invention. Other locking mechanisms that lock support member 110 in the extended position may be used.

As shown in FIG. 1 and FIG. 2, the embodiment of the present invention illustrated by apparatus 100 advantageously allows a person to hold and transport their golf clubs without carrying their golf clubs or apparatus 100. Rather, support member 110 and wheels 108 support the weight of apparatus 100 and any equipment held within apparatus 100, so that a person simply pulls handle 120 to transport their golf clubs. Compared with conventional golf travel bags and pull carts that have only two wheels, apparatus 100 avoids putting strain on a person's shoulders, arms and/or back because they do not have to carry the weight of apparatus 100. Moreover, because apparatus 100 allows a person to hold their golf clubs, as well as conveniently transport their golf clubs, they do not have to buy separate piece of equipment to hold their clubs, to travel with their clubs or to transport their clubs on a golf course, i.e., the golf bag, the travel bag and the pull cart are integrated into a single apparatus. However, it should be appreciated that apparatus 100 and other embodiments of the present invention may be used as a travel bag or pull cart. In other words, someone who owns a golf bag may place the golf bag within container 102.

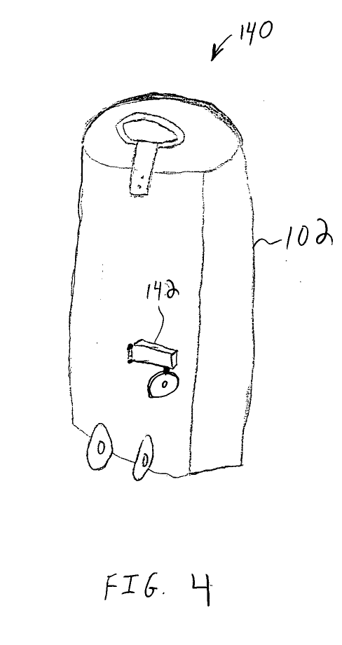

Referring now to FIG. 4, FIG. 4 shows a perspective view of apparatus 140, which is an embodiment of the present invention that includes similar parts as apparatus 100. All parts of apparatus 140, which are similar to parts previously described with respect to FIGS. 1 and 2 are numbered the same as in FIGS. 1 and 2. Like apparatus 100, apparatus 140 includes a support member 142 that is pivotally connected to a container 102. Support member 142 is pivotable from a stored position to an extended position, as described above with respect to support member 110 of apparatus 100. The difference between support member 110 and support member 142 is that support member 142 pivots about a vertical axis when apparatus 140 is in the upright position as shown in FIG. 4, while support member 110 pivots about a horizontal axis when apparatus 100 is in the upright position as shown in FIGS. 1 and 2. Apparatus 100 and apparatus 140 are merely two examples of embodiments of the present invention. It should be appreciated that in other embodiments support member(s) may pivot about an axis that is between horizontal and vertical, when the apparatus is in an upright position, and still be within the scope of the present invention.

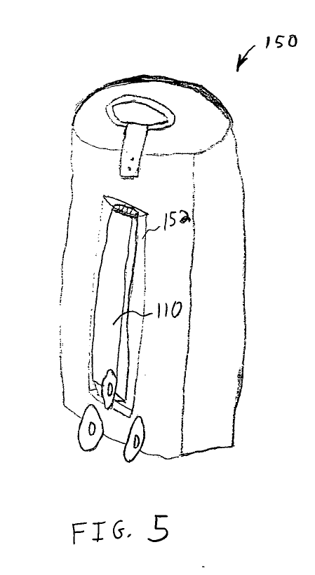

FIG. 5 shows another embodiment of the present invention showing apparatus 150 that includes a support member storage groove 152. Parts similar to those of apparatus 100 are numbered the same as in FIG. 1 and FIG. 2. Support member storage groove 152 is a space or volume where at least a portion of support arm 110 is disposed when the support member is in the stored position. In some embodiments of the present invention, the support member 110 will be completely disposed in support member storage groove 152, when in the support member stored position. In yet other embodiments, the support member 110 and the support wheel 118 will be completely disposed in support member storage groove 152, when the support member 110 is in the support member stored position. Those embodiments of the present invention that include more than one support member, may also include more than one support member storage groove.

In some embodiments, apparatus 150 may include a support member storage groove cover, which may be used to at least partially cover the support member storage groove, whether the support member 110 is in the support member storage groove 152 or not. The cover may include any suitable device(s) that allows the cover to be opened and closed. For example, the cover may simply be one or more pieces of material that cover the support member storage groove and include a fastener such as button(s), hook and loop fastener, zipper(s), latch(es) or combinations thereof to close the support member storage groove cover. As another example, the support member storage groove cover may be a piece of hard plastic that is slid open and closed. Accordingly, the support member storage groove cover is not limited to the embodiments described above and may include other devices or designs.

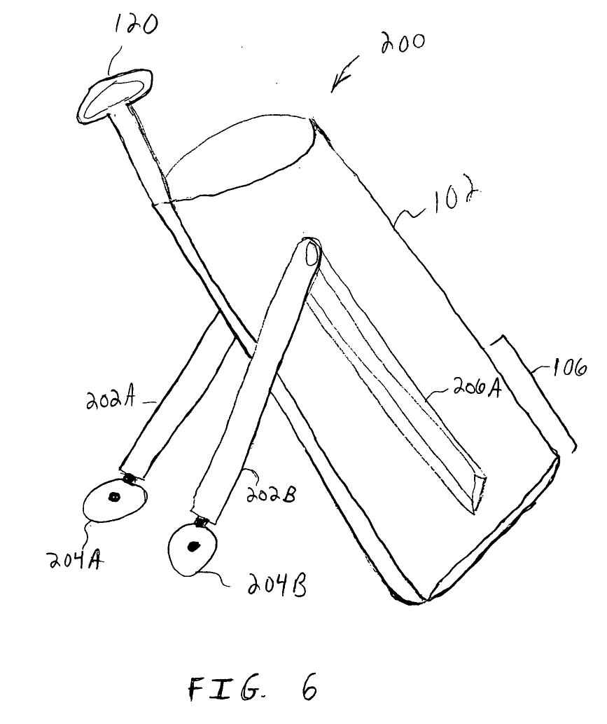

FIG. 6 is a perspective view of apparatus 200, which is another embodiment of the present invention. All parts of apparatus 140, which are similar to parts previously described with respect to FIGS. 1 and 2 are numbered the same as in FIGS. 1 and 2. Apparatus 200 includes container 102 as previously described. Apparatus 200 also includes a handle 120 connected to container 102. Container 102 includes a base 106, which in contrast to apparatus 100 does not include wheels—although in other embodiments it may. Apparatus 200 includes two support members 202A and 202B, which support apparatus 200 in an inclined position. Support members 202A and 202B are similar to previously described support member 110, described above with respect to FIGS. 1 and 2. Rotatably connected to each support member are support wheels 204A and 204B. Support wheels 204A and 204B allow apparatus 200 to be easily transported by tilting apparatus 200, so that the weight of apparatus 200 is supported by support members 202A and 202B, and pulling apparatus 200 using handle 120. Additionally, apparatus 200 includes support member storage grooves 206A and 206B (not shown). Support member storage grooves 206A and 206B, are similar to previously described support member storage groove 152.

Support wheels 204A and 204B are similar to wheels 108 and support wheel 118 described above. Support wheels 204A and 204B have a horizontal axis of rotation about which they rotate when apparatus 200 is being rolled along the ground. In other embodiments the wheels 204A and 204B may have an axis of rotation that is different than horizontal when being rolled along the ground. Additionally, in some embodiments support wheels 204A and 204B may rotate about more than one axis of rotation, such as a vertical axis of rotation, providing better steering control over apparatus 200. For example, the wheels may rotate about a vertical axis of rotation when being rolled along the ground to allow the wheels to turn while they are rolling.

Apparatus 200 allows a person to hold their golf clubs, as well as conveniently transport their golf clubs. It is not necessary to buy separate pieces of equipment to hold golf clubs, to travel with golf clubs and to transport golf clubs on a golf course. Advantageously, a golf bag, a travel bag and a pull cart are integrated into a single apparatus. However, it should be appreciated that apparatus 200 and other embodiments of the present invention may be used as a travel bag or pull cart. In other words, someone who owns a golf bag may place the golf bag within container 102.

Any feature described or claimed with respect to any disclosed embodiment may be combined in any combination with any one or more other feature(s) described or claimed with respect to any other disclosed embodiment, to the extent that the features are not necessarily technically incompatible, and all such combinations are within the scope of the present invention. Without limiting the general applicability of the foregoing, any one or more of the support member(s), wheel(s), support wheel(s), container(s), handle(s) or storage groove(s), described with respect to any one or more of the figures may be combined in any combination with any one or more of the same or other of such features, whether or not any such specific combination is expressly disclosed herein. Furthermore, the claims appended below set forth some nonlimiting combinations of features within the scope of the invention, but also contemplated as being within the scope of the invention are all possible combinations of the subject matter of any two or more of the claims, in any possible combination, provided that the combination is not necessarily technically incompatible.

The terms “comprise”, “include”, “have” and “contain”, and variations of those terms, are intended to indicate only that a particular feature or attribute is present, and are not intended to limit the presence of other features or attributes.

I claim:

1. An apparatus for holding and transporting golf clubs, the apparatus comprising:
a container configured to hold golf clubs;
a first base wheel rotatably connected to a base of the container;
a first support member, wherein a first end of the first support member is pivotally connected to the container; and
a first support wheel rotatably connected to a second end of the first support member, wherein the first support member is pivotable from a first support member stored position to a first support member extended position.

2. The apparatus of claim 1, further comprising a second base wheel rotatably connected to the base of the container.

3. The apparatus of claim 1, further comprising a handle connected to the container.

4. The apparatus of claim 3, wherein the handle is movable from a stored handle position to an extended handle position.

5. The apparatus of claim 4, further comprising a handle storage groove, wherein when the handle is in the stored handle position, the handle is at least partially disposed within the handle storage groove.

6. The apparatus of claim 1, further comprising a first support member storage groove, wherein when the first support member is in the first support member stored position it is at least partially disposed within the first support member storage groove.

7. The apparatus of claim 1, further comprising a locking mechanism for locking the first support member in the first support member extended position.

8. The apparatus of claim 7, wherein the locking mechanism comprises:
a first locking member pivotally connected to the container; and
a second locking member pivotally connected to the first locking member on a first end and pivotally connected to the first support member on a second end.

9. The apparatus of claim 1, further comprising:
a second support member, wherein a first end of the second support member is pivotally connected to the container; and
a second support wheel rotatably connected to a second end of the second support member, wherein the second support member is pivotable from a second support member stored position to a second support member extended position.

10. The apparatus of claim 9, further comprising a second support member storage groove, wherein when the second support member is in the second support member stored position it is at least partially disposed within the second support member storage groove.

11. An apparatus for holding and transporting golf clubs, the apparatus comprising:
a container configured to hold golf clubs;
a first base wheel rotatably connected to a base of the container;
a second base wheel rotatably connected to the base of the container;
a support member pivotally connected to the container, wherein the support member is pivotable from a support member stored position to a support member extended position;
a support wheel rotatably connected to a second end of the support member; and
a handle connected to the container.

12. The apparatus of claim 11, wherein the container comprises a hard outer shell.

13. The apparatus of claim 11, wherein the container comprises a soft outer shell.

14. The apparatus of claim 11, further comprising a support member storage groove, wherein when the support member is in the support member stored position, the support member is at least partially disposed within the support member storage groove.

15. The apparatus of claim 14, further comprising a storage groove cover, wherein the storage groove cover may be closed to cover at least a portion of the storage groove.

16. The apparatus of claim 11, further comprising a locking mechanism for locking the support member in the support member extended position.

17. The apparatus of claim 11, wherein the handle is movable from a stored handle position to an extended handle position.

18. The apparatus of claim 11, wherein the first wheel and the second wheel are rotatable about a first horizontal axis of rotation.

19. The apparatus of claim 18, wherein the support wheel is rotatable about a second horizontal axis of rotation.

20. The apparatus of claim 19, wherein the support wheel is rotatable about a vertical axis of rotation.

21. An apparatus for holding and transporting golf clubs comprising:
a container configured to hold golf clubs;
first rolling means for rolling the apparatus, wherein the first rolling means is rotatably connected to a base of the container;
support means for supporting at least a portion of the apparatus when the apparatus is being rolled, wherein the support means is connected to the container; and
second rolling means for rolling the apparatus, wherein the second rolling means is rotatably connected to the support means.

22. An apparatus for holding and transporting golf clubs, the apparatus comprising:
a container configured to hold golf clubs;
a first support member, wherein a first end of the first support member is pivotally connected to the container;
a first support wheel rotatably connected to a second end of the first support member, wherein the first support member is pivotable from a first support member stored position to a first support member extended position;
a second support member, wherein a first end of the second support member is pivotally connected to the container; and
a second support wheel rotatably connected to a second end of the second support member, wherein the second support member is pivotable from a second support member stored position to a second support member extended position.
